(19) United States
(12) Patent Application Publication
(10) Pub. No.: US 2014/0279128 A1
(43) Pub. Date: Sep. 18, 2014

(54) ACCESSING MEDIA CONTENT IN A MEDIA MANAGEMENT SYSTEM

(71) Applicant: Rodrigo SAGEBIN, Salt Lake City, UT (US)

(72) Inventor: Rodrigo SAGEBIN, Salt Lake City, UT (US)

(21) Appl. No.: 14/189,594

(22) Filed: Feb. 25, 2014

Related U.S. Application Data
(60) Provisional application No. 61/784,709, filed on Mar. 14, 2013.

(51) Int. Cl. H04L 29/06; G06Q 20/12

(52) U.S. Cl. CPC H04L 63/10; G06Q 20/1235
USPC 705/26.1; 726/29

(57) ABSTRACT

A method for accessing media content may include converting an artistic item on a hard-copy media implementation to a digital media file. The method may also include receiving a first request to access the digital media file from a client device. The method may include determining that the digital media file is available for the client device to access. The method may include approving the first request by providing a presentation of the digital media file to the client device. The method may further include receiving a second request from the client device to add one or more features to the presentation of the digital media file. The method may include adding the one or more features to the presentation of the digital media file.

### CROSS-REFERENCE TO RELATED APPLICATIONS

This application is based upon and claims the benefit of priority of U.S. Provisional Application No. 61/784,709, filed on Mar. 14, 2013. The entirety of the foregoing application is incorporated herein by reference.

### FIELD

The embodiments discussed herein are related to accessing media content in a media management system.

### BACKGROUND

A first user that has purchased a tangible medium with copyright content from a content owner may share the copyright content with a second user by lending the tangible medium to the second user. Examples of the tangible medium may include a digital versatile disc (DVD), a compact disc (CD), a Blu-Ray Disc, a MiniDisc, and another suitable physical medium format, etc. The second user may be a friend, a family member, or a neighbor, etc. of the first user. Also, the first user may want to modernize his or her entertainment libraries by converting the purchased copyright content from the tangle medium format to a digital format. The conversion and sharing capability of the copyright content in the tangible medium may be expected to conform to some copyright protection parameters that the content owner has envisioned in the pricing strategies when the copyright content in the tangible medium was released to the public for purchase. For example, the first user may lend the tangible medium to one friend at a time; however, neither the first user nor the friend is allowed to make pirated copies of the copyright content in the tangible medium. However, existing solutions may fail to prevent the first user and/or the second user from making illegal copies of the copyright content in the tangible medium and may therefore fail to protect the copyright content. Additionally, neither the first user nor the second user may customize a presentation of the copyright content in the tangible medium, where the customization may conform to copyright protection rules and/or protection parameters configured by the content owner of the copyright content. For example, a user may not add a subtitle to a replay of a DVD if the DVD does not include the subtitle even if the content owner may allow the user to add such a subtitle to the replay.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method for accessing media content in a media management system may include converting an artistic item on a hard-copy media implementation to a digital media file. The method may also include receiving a first request to access the digital media file from a client device. The method may include determining that the digital media file is available for the client device to access and approving the first request by providing a presentation of the digital media file to the client device. The method may further include receiving a second request from the client device to add one or more features to the presentation of the digital media file and adding the one or more features to the presentation of the digital media file.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example system configured to manage media content for users;

FIG. 2 illustrates an example server including an example media management apparatus configured to manage digital media files converted from hard-copy media implementations;

FIG. 3 is a flowchart of an example method of accessing media content;

FIG. 4 is a flowchart of an example method of creating a digital media file from a hard-copy media implementation;

FIGS. 5A and 5B are flowcharts of another example method of accessing media content; and

FIG. 6 is a graphic representation of an example record describing an association between a hard-copy media implementation and a digital media file converted from the hard-copy media implementation.

### DESCRIPTION OF EMBODIMENTS

As described in further detail below, a media management apparatus may be configured to convert artistic content on hard-copy media implementations to corresponding digital media files. The media management apparatus may also be configured to manage the digital media files for users that own the hard-copy media implementations. The media management apparatus may allow the users to access the digital media files; to lend the digital media files to friends, family members, or other acquaintances; to sell the digital media files; or to purchase new digital media files from media sources. The media management apparatus may also edit the presentation of the digital media files by adding one or more features to the presentation of the digital media files. For example, the media management apparatus may edit a digital movie file derived from a movie DVD by adding a subtitle to the digital movie file that is not a part of the movie DVD. The addition of the one or more features does not modify the copyright-protected content in the digital media files. The media management apparatus may also allow owners of digital media files to upgrade the digital media files.

The present disclosure may be particularly advantageous in a number of respects. For example, as described herein, the media management apparatus may convert artistic content on hard-copy media implementations owned by a user to digital media files and may manage the digital media files for the user. Therefore, the user may use the digital media files conveniently with no need to interact with the hard-copy media implementations. For example, the user may access the digital media files and may share the digital media files with friends without interacting with the hard-copy media implementations. In addition, by storing users' hard-copy media implementations in a repository and controlling access to the corresponding digital media files, the technologies described herein may help content owners that own artistic content in the hard-copy media implementations to protect the artistic content from copyright infringement.

As another example, the media management apparatus may convert each hard-copy media implementation to a single digital version of the hard-copy media implementation, thereby conforming to the copyright protection requirements for media. The single digital version of the hard-copy media implementation may include one or more digital media files corresponding to one or more artistic items stored on the hard-copy media implementation. The hard-copy media implementation may be associated with a unique authorization code (e.g., a unique serial number), where the unique authorization code may act as a key permitting private transmission of the hard-copy media implementation and/or the corresponding digital media file to an authorized viewer of the hard-copy media implementation and/or the corresponding digital media file. In some embodiments, each digital media file may be accessed by a single user at a time. The media management apparatus may also place restrictions on the sharing of the digital media files. For example, the media management apparatus may restrict a total number of users that may receive a particular digital media file loaned from an owner and may establish a loan term for loaning the particular digital media file.

In yet another example, the media management apparatus may add one or more features to a presentation of a digital media file without modifying the copyright-protected content included in the digital media file. The media management apparatus may present the one or more features to a user when the digital media file is presented to the user. In still yet another example, the media management apparatus may also allow an owner of a digital media file to upgrade the digital media file. The advantages described herein are provided by way of example, and the media management apparatus may have numerous other advantages that are not described herein.

Embodiments of the present disclosure will be explained with reference to the accompanying drawings.

FIG. 1 illustrates a block diagram of an example system 100 configured to manage media content for users, according to at least one embodiment of the present disclosure. The system 100 may include a social network server 103, a media source 107, a server 109, a repository 111, and client devices 119a-119n (also referred to individually and collectively as “client device 119”) that may be accessed by users 125a-125n (also referred to individually and collectively as “user 125”). Although the system 100 is illustrated as including one social network server 103, one media source 107, one server 109, one repository 111, and two client devices 119, the system 100 may include any number of social network servers 103, media sources 107, servers 109, repositories 111, and client devices 119. Additionally, in some embodiments the system 100 may include other entities not illustrated in FIG. 1, such as a web server, a search server, etc.

In the illustrated embodiment, entities of the system 100 may be communicatively coupled via a communication network 105 (referred to hereinafter as “network 105”). In some embodiments, the network 105 may include, either alone or in any suitable combination, the Internet, an Intranet, a local Wireless Fidelity (“Wi-Fi”) network, a wireless local area network (“LAN”), a mobile network (e.g., a third generation (“3G”), a fourth generation (“4G”), and/or long term evolution (“LTE”) network), a LAN, a wide area network (“WAN”), or any other suitable communication network.

The repository 111 may be configured to store hard-copy media implementations received from users that own the hard-copy media implementations. For example, the repository 111 may include a single central warehouse where all hard-copy media implementations may be stored. In another example, the repository 111 may include multiple regional warehouses where the hard-copy media implementations may be stored.

The term “hard-copy media implementation” in the present disclosure may refer to any suitable physical media file or material that includes artistic content. In some embodiments, the artistic content may be protected by copyright. For example, a hard-copy media implementation may include a book, a CD (e.g., an album, an audio book, etc.), a DVD (e.g., a movie DVD), a Blu-Ray disc, a MiniDisc, a video home system (VHS) tape, a printed photograph, or any physical media material including artistic content.

A user that owns a hard-copy media implementation may be referred to herein as an owner of the hard-copy media implementation. For example, an owner of a hard-copy media implementation may be a user that purchases the hard-copy media implementation from a retailer. In some embodiments, owners of hard-copy media implementations may send the hard-copy media implementations to be stored in the repository 111. For example, an owner may ship his movie DVDs to an entity that manages the repository 111 so that his movie DVDs may be stored in the repository 111. The owners of the hard-copy media implementations may retain the ownership rights to the hard-copy media implementations stored in the repository 111. Although the owners may temporarily suspend their ability to access the hard-copy media implementations by storing the hard-copy media implementations in the repository 111, the owners may be rewarded with the ability to access digital versions, e.g., digital copies, of the artistic content on the hard-copy media implementations from anywhere at any time via the network 105 as described below in more detail. The hard-copy media implementations stored in the repository 111 may be received by a media management apparatus 113 for converting them to digital media files as described below in more detail.

The server 109 may be a hardware server that includes a processor 115, a memory 117, and network communication capabilities. In the illustrated embodiment, the server 109 is coupled to the network 105 via a signal line 106. The server 109 may also include the media management apparatus 113, a communication unit 137, and a storage device 135.

As illustrated in FIG. 1, the media management apparatus 113 may be part of the server 109 and accessible by the client device 119 via the network 105. In some embodiments, the media management apparatus 113 may be installed on or accessible by a computing device, such as a desktop computer, workstation, laptop computer, tablet computer, a mobile computing device (e.g., a cellular phone or smartphone), or any other computing device with access to the network 105. The server 109 may be part of a cloud computing environment accessible by the computing device. One skilled in the art will recognize that there may be numerous other ways of implementing the media management apparatus 113 for user access via a computing device.

The media management apparatus 113 included in the server 109 may be configured to receive hard-copy media implementations from the repository 111. The media management apparatus 113 may be configured to convert the artistic content on the received hard-copy media implementations into digital media files. The digital media files may be digital versions of the artistic content on the hard-copy media implementations and may be accessible by users 125 via the network 105. Each individual piece of artistic content on the hard-copy media implementation may be converted to a single digital media file that is owned by the owner of the hard-copy media implementation. For example, a movie on a DVD may be converted to a single digital media file. As another example, each song on a CD with multiple songs may be converted to a single digital media file. Thus, a CD with fifteen songs may have fifteen digital media files created from a conversion of the CD. Alternatively or additionally, the artistic content on the CD may be converted to a single digital media file so that the digital media file includes all of the songs on the CD.

Each digital media file may be identified by a unique authorization code associated with the corresponding hard-copy media implementation. An authorization code may be information used to authenticate that a user owns a hard-copy media implementation. For example, an authorization code may be a serial number or a key associated with a hard-copy media implementation. In some embodiments, an authorization code may be used by an owner of a digital media file converted from the hard-copy media implementation to authorize another user access to the digital media file.

The media management apparatus 113 may also be configured to manage the digital media files converted from the hard-copy media implementations. For example, the media management apparatus 113 may be configured to manage accessing, sharing, selling, and upgrading of the digital media files. The media management apparatus 113 may also be configured to add one or more features to the presentation of the digital media files. The media management apparatus 113 is described below in more detail with reference to FIGS. 2-5B.

The processor 115 may include, for example, a microprocessor, microcontroller, a digital signal processor (“DSP”), an application-specific integrated circuit (“ASIC”), a Field-Programmable Gate Array (“FPGA”), or any other digital or analog circuitry configured to interpret and/or to execute program instructions and/or to process data. In some embodiments, the processor 115 may interpret and/or execute program instructions and/or process data stored in the associated memory 117 and/or the storage device 135. Although a single processor 115 is illustrated in FIG. 1, the server 109 may include multiple processors 115.

The memory 117 may include any suitable computer-readable media configured to retain program instructions and/or data for a period of time. By way of example, and not limitation, such computer-readable media may include tangible and/or non-transitory computer-readable storage media, including Random Access Memory (“RAM”), Read-Only Memory (“ROM”), Electrically Erasable Programmable Read-Only Memory (“EEPROM”), Compact Disk Read-Only Memory (“CD-ROM”) or other optical disk storage, magnetic disk storage or other magnetic storage devices, flash memory devices (e.g., solid state memory devices), a specific molecular sequence (e.g., DNA or RNA), or any other storage medium which may be used to carry or store desired program code in the form of computer-executable instructions or data structures and which may be accessed by the processor 115. Combinations of the above may also be included within the scope of computer-readable media. Computer-executable instructions may include, for example, instructions and data that cause a general purpose computer, special purpose computer, or special purpose processing device (e.g., the processor 115) to perform a certain function or group of functions.

The storage device 135 may be any suitable computer-readable medium configured to store data and/or data objects for providing the functionality described herein. The storage device 135 may be a dynamic random access memory (“DRAM”) device, a static random access memory (“SRAM”) device, flash memory, or some other memory devices. In some embodiments, the storage device 135 may also include a non-volatile memory or similar permanent storage device and media including a hard disk drive, a floppy disk drive, a CDROM device, a DVDROM device, a DVDRAM device, a DVDRW device, a flash memory device, or some other mass storage device for storing information on a more permanent basis.

In some embodiments, the storage device 135 may store digital media files, file settings, and share settings associated with the digital media files. The file settings and share settings are described below in more detail. The storage device 135 may store any other data for providing the functionality described herein.

The communication unit 137 may provide any suitable form of communication capability between the server 109 and other entities in FIG. 1, such as the client devices 119, the social network server 103, and the media source 107. By way of example and not limitation, the communication unit 137 may be configured to provide, via wired and/or wireless mechanisms, Internet connectivity, LAN connectivity, WAN connectivity, Bluetooth connectivity, 3G connectivity, 4G connectivity, LTE connectivity, Wi-Fi connectivity, Machine-to-Machine (“M2M”) connectivity, Device-to-Device (“D2D”) connectivity, any other suitable communication capability, or any suitable combination thereof. Although not expressly depicted in FIG. 1, in these and other embodiments, the communication unit 137 may provide direct connectivity between the server 109 and other entities of the system 100.

The social network server 103 may be a hardware server that includes a processor, a memory, and network communication capabilities. In the illustrated embodiment, the social network server 103 is coupled to the network 105 via a signal line 102. The social network server 103 may send and receive data to and from one or more of the media source 107, the server 109, and the client devices 119 via the network 105.

The social network server 103 may include a social network application (not shown) for providing a social network to users. A social network may be a type of social structure where the users 125 may be connected by a common feature. The common feature may include relationships/connections, e.g., friendship, family, work, interest(s), etc. The common features may be provided by one or more social networking systems including explicitly defined relationships and relationships implied by social connections with other online users, where the relationships may form a social graph. In some examples, the social graph may reflect a mapping of these users and how they may be related. Furthermore, it should be understood that the social network server 103 may be representative of one social network and that there may be multiple social networks coupled to the network 105, each having its own server(s), application(s), and social graph(s).

The media source 107 may be a media provider configured to provide media content to users. The media source 107 may include movie production companies, music record labels, individual artists, and media distribution entities, among others. For example, the media source 107 may be a manufacturer, a producer, or a distributor that wishes to include media items to be sold via the media management system 100. In some embodiments, the media source 107 may be a seller that has registered with the media management system 100 to sell media items.

The media source 107 may also include a computing device operated by a movie production company, a music record label, an individual artist, or a media distribution entity, etc. In the illustrated embodiment, the media source 107 is coupled to the network 105 via a signal line 104. In some embodiments, the users 125 may purchase new instances of media content directly from the media source 107 instead of purchasing used media content from other of the users 125. The new media content purchased from the media source 107 may include a hard-copy media implementation, a digital version of the hard-copy media implementation, or both. The hard-copy media implementation may be stored in the repository 111 or shipped to physical addresses of the users 125.

The client device 119 may be a computing device that includes a memory, and a processor, for example, a laptop computer, a desktop computer, a tablet computer, a mobile telephone, a personal digital assistant (“PDA”), a mobile e-mail device, a portable game player, a portable music player, a television with one or more processors embedded therein or coupled thereto, or another electronic device capable of accessing the network 105. In some embodiments, the client device 119 may include a browser (not shown) for accessing online services. For example, the client device 119 may include a browser for accessing digital media files from the server 109. In the illustrated embodiment, the client device 119a is communicatively coupled to the network 105 via a signal line 108. The user 125a may interact with the client device 119a via a signal line 112. The client device 119n is communicatively coupled to the network 105 via a signal line 110. The user 125n may interact with the client device 119n via a signal line 114.

Throughout the present disclosure, in some embodiments, the user 125 may refer to an owner of a hard-copy media implementation and/or a corresponding digital media file. In some embodiments, the user 125 may refer to a person that does not own an original hard-copy media implementation and that may request to borrow a digital version of the hard-copy media implementation from an owner of the digital version. In some embodiments, the user 125 may refer to a person that does not own any digital media files in the media management system 100 but nonetheless participates in the media management system 100. Alternatively or additionally, the user 125 may refer to a person that merely agrees to the terms of the loan agreement. In other words, the user 125 may be any user and may not be limited to a person that participates in the media management system 100.

It should be understood that modifications, additions, or omissions may be made to the system 100 without departing from the scope of the present disclosure. The separation of various components and servers in the embodiments described herein should not be understood as requiring such separation in all embodiments. It should be understood that the described components and servers may generally be integrated together in a single component, device, or server.

Referring now to FIG. 2, the server 109 including the example media management apparatus 113 is illustrated in more detail, according to at least one embodiment described herein. In the illustrated embodiment, the processor 115, the memory 117, the storage device 135, and the communication unit 137 in the server 109 may be communicatively coupled to a bus 280.

In some embodiments, the media management apparatus 113 may include a communication module 202, a conversion module 204, a configuration module 206, an access module 208, a lending module 210, a sales module 212, an account module 214, an analytics module 216, an advertising module 218, a user interface module 220, a search module 222, a feature module 224, an upgrade module 226, and a payment module 228. In some embodiments, the modules of the media management apparatus 113 may be communicatively coupled to the bus 280.

The discussion of the example of the media management apparatus 113 illustrated in FIG. 2 is made in the context of the system 100 of FIG. 1. In particular, the discussion with respect to FIG. 2 describes how the different modules of the media management apparatus 113 may, in some embodiments, interact, communicate, or otherwise associate with components of the system 100 of FIG. 1.

In some embodiments, the modules of the media management apparatus 113 may be instructions executable by the processor 115 to provide the functionality described below. In some embodiments, the modules of the media management apparatus 113 may be stored in the memory 117 of the server 109 and may be accessible and executable by the processor 115. In these or other embodiments, the modules of the media management apparatus 113 may be adapted for cooperation and communication with the processor 115 and other components of the server 109 via the bus 280.

It should be understood that modifications, additions, or omissions may be made to the example media management apparatus 113 without departing from the scope of the present disclosure. The separation of various modules in the embodiments described herein should not be understood as requiring such separation in all embodiments, and it should be understood that the described modules may generally be integrated together in a single component, or multiple components.

The communication module 202 may be software including routines for handling communications between the media management apparatus 113 and other modules of the system 100. The communication module 202 may send and receive data, via the communication unit 137, to and from one or more of the client devices 119, the social network server 103, and the media source 107 via the network 105. For example, the communication module 202 may receive, via the communication unit 137, social graph data associated with a user from the social network server 103 and may send the social graph data to the configuration module 206. In another example, the communication module 202 may receive graphical data for providing a user interface to a user from the user interface module 220. The communication module 202 may send the graphical data to the client device 119 via the network 105, causing the client device 119 to present the user interface to the user.

In some embodiments, the communication module 202 may receive data from modules of the media management apparatus 113 and may store the data in the storage device 135 and/or the memory 117. For example, the communication module 202 may receive a digital media file from the conversion module 204 and may store the digital media file in the storage device 135. In some embodiments, the communication module 202 may receive data from the storage device 135 or the memory 117 and may send the data to one or more modules of the media management apparatus 113. For example, the communication module 202 may receive data describing a share setting for a digital media file from the storage device 135 and may send the data to the lending module 210. In some embodiments, the communication module 202 may also handle communications between modules of the media management apparatus 113.

The conversion module 204 may be software including routines for converting artistic content on hard-copy media implementations into digital media files. In some embodiments, the conversion module 204 may be configured to receive a hard-copy media implementation from the repository 111. In some embodiments, the conversion module 204 may include a verification system that may verify whether the hard-copy media implementation includes legally owned originals of the artistic content before converting each of the artistic items on the hard-copy media implementation into a digital media file. For example, the conversion module 204 may verify whether an authorization code associated with the hard-copy media implementation is a genuine code. In another example, the conversion module 204 may verify whether the original digital rights management (“DRM”) technologies are active on the hard-copy media implementation. In yet another example, the conversion module 204 may verify whether the hard-copy media implementation is a legal copy of the hard-copy media implementation, e.g., is not a pirated copy of the hard-copy implementation.

In some embodiments, when the conversion module 204 determines that the hard-copy media implementation is legally owned by a user, the conversion module 204 may convert each of the artistic items on the hard-copy media implementation to a single digital media file for the user. For example, the conversion module 204 may convert a movie on a DVD owned by a user into a digital media file. The digital media file may have an mp4 format, an avi format, an mkv format, or any other suitable format. In another example, the conversion module 204 may convert each track on a CD into a digital media file, where each digital media file may have an mp3 format, a free lossless audio codec (“FLAC”) format, or a waveform audio file format (“WAVE”), etc. In these and other examples, the digital media file may have another proprietary format that may further protect the artistic content from piracy. The conversion module 204 may store the digital media file in the storage device 135 for the user so that the digital media file may be accessed online via the network 105.

An ownership right associated with a digital media file may be substantially similar to the corresponding right associated with the original hard-copy media implementation. For example, if a legally owned DVD was sent by an owner to the repository 111 and converted to a digital media file, the owner may be granted with a set of rights for the digital media file similar to those rights for the hard-copy DVD. For example, the owner may retain a right to access the digital media file, referred to herein as an access right, a right to sell the digital media file to another user, and a right to temporarily grant the access right of the digital media file to another user (e.g., a right to utilize the hard-copy media implementation in a modern manner within the same context that a corresponding content owner envisioned for the hard-copy media implementation), etc.

The configuration module 206 may be software including routines for configuring digital media files converted from hard-copy media implementations. In some embodiments, the configuration module 206 may configure a file setting for each digital media file. A file setting may include a title, a brief description, an authorization code (e.g., a serial number), an owner, a file type (e.g., a video file, an audio file, a text file, an image file, etc.), or any other metadata associated with the digital media file. For example, the configuration module 206 may configure a title, a brief description, an authorization code, or other metadata associated with a digital media file based on the hard-copy media implementation. In another example, the configuration module 206 may configure an owner of the digital media file to be the same owner of the hard-copy media implementation.

In some embodiments, the configuration module 206 may configure a share setting for each digital media file. A share setting of a digital media file may include data describing how the digital media file may be shared. In some embodiments, a share setting of a digital media file may indicate that the digital media file may be accessed by one user at one time, which is similar to the interaction that occurs between friends, family members, neighbors, or others when sharing a hard-copy media implementation. The configuration module 206 may configure a share setting for a digital media file so that an owner of the digital media file may temporarily authorize another user access to the digital media file. However, when the digital media file is “on-loan” to another user, the owner may temporarily forfeit his or her access to the digital media file. This scenario is similar to how the owner's access right to a movie DVD would be temporarily forfeited when the movie DVD has been loaned to another user. Also, in these and other embodiments, the owner may not be permitted to loan the digital media file to more than one user at one time. In some embodiments, the sharing setting may include one or more protocols describing rules for connecting to other users. For example, the sharing setting may include protocols that may prevent an owner of a digital media file from connecting to all of the other users as a friend and sharing a particular digital media file with all of the other users. For example, the sharing setting may include protocols describing that the owner may connect to a limited number of users such that the digital media file may be shared with the limited number of other users. In these and other embodiments, the restricted sharing may be similar to sharing of hard-copy media implementations that occurred in neighborhoods with a limited number of people.

In some embodiments, a share setting of a digital media file may indicate that the digital media file may be accessed by up to a maximum number of users at a time. For example, a maximum number of users may be one user so that the digital media file may be accessed by one user at a time. As another example, a maximum number of users may be an integer greater than one (e.g., 2, 3, 4, etc.) so that the digital media file may be accessed by up to the maximum number of users at a time. In yet another example, an initial maximum number of users allowed to access a digital media file at a time may be one. An owner of the digital media file may pay for an upgrade of the access right of the digital media file so that the digital media file may be accessed by up to three users at a time or some other numbers of users at a time.

In some embodiments, a share setting of a digital media file may include a share list specifying one or more other users that the owner would like to share the digital media file with. For example, the share list may include one or more people, such as friends, family members, or other acquaintance, with whom the owner agrees to share the digital media file. In some embodiments, a share list may not include more than a predetermined number of users. For example, a total number of users included in a share list may not exceed ten, indicating the owner may not share the digital media file with more than ten other users.

The configuration module 206 may synchronize and/or coordinate with social media websites to utilize certain groupings or personal networks already established in those social media websites for configuring share lists of the digital media files. For example, the configuration module 206 may create a share list for a digital media file owned by a user based on a social graph associated with the user in a social network, where the share list may include friends, family members, or other acquaintance of the user in the social graph. Alternatively or additionally, in some embodiments, the configuration module 206 may refer to a user's cell phone directory or a user's e-mail directory to establish a share list for a digital media file owned by the user, where the share list may include contacts in the cell phone directory or e-mail directory.

In some embodiments, an owner of a digital media file may manually configure a file setting and a share setting for the digital media file. For example, the configuration module 206 may instruct the user interface module 220 to generate graphical data for providing a user interface to the owner of the digital media file so that the owner may provide input data for configuring the file setting and the share setting of the digital media file via the user interface.

In some embodiments, the configuration module 206 may send the file setting and/or the share setting of the digital media file to one or more of the access module 208 and the lending module 210. Alternatively or additionally, in some embodiments, the configuration module 206 may store the file setting and/or the share setting in the storage device 135.

The access module 208 may be software including routines for providing access to digital media files for users. In some embodiments, the access module 208 may receive an access request to access a digital media file from the client device 119 operated by a user. The access module 208 may determine whether the user of the client device 119 is an owner of the digital media file. If the user is not an owner of the digital media file, the access module 208 may determine whether the user has an access right to access the digital media file. For example, the access module 208 may determine whether the user has already borrowed the digital media file from the owner and whether the loan term of the digital media file is still valid.

If the user has already been granted an access right to access the digital media file, the access module 208 may allow the user to access the digital media file. For example, if the user has already borrowed the digital media file from the owner and a loan term of the digital media file for the user has not yet expired, the access module 208 may allow the user to view or listen to the digital media file online via the network 105. In another example, the access module 208 may send the digital media file to the client device 119 associated with the user for presenting the digital media file on the client device 119. However, if the user is not an owner of the digital media file and does not have an access right to access the digital media file, the access module 208 may deny the user access to the digital media file.

Alternatively, if the user is the owner of the digital media file, the access module 208 may determine whether an access right of the digital media file has been granted to a maximum number of users that are allowed to access the digital media file at one time. For example, the access module 208 may determine whether a total number of users that have borrowed the digital media file is equal to the maximum number of users. If the access right has not been granted to the maximum number of users (e.g., while the total number of users that have been granted the access right of the digital media file is less than the maximum number of users), the access module 208 may allow the owner to access the digital media file. For example, the access module 208 may allow the owner to view or listen to the digital media file, configure a file setting or a share setting for the digital media file, or sell the digital media file.

If the access right of the digital media file is already granted to the maximum number of users (e.g., while the total number of users that have been granted the access right of the digital media file is equal to the maximum number of users), the access module 208 may deny the owner access to the digital media file. However, in some embodiments, the owner of the digital media file may revoke the access rights granted to one or more other users and may reinstate his or her access to the digital media file at any time.

In some embodiments, the digital media file requested by the user may have multiple versions. For example, the digital media file may have an original version derived from a hard-copy media implementation, and an upgraded version purchased by an owner of the digital media file. As another example, a particular movie may have a standard version derived from a DVD, a high definition (HD) version upgraded by an owner of the DVD, and a Blu-Ray disc (BD) version upgraded by the owner. In some embodiments, the access module 208 may determine which version of the digital media file is available for the user to access. The access module 208 may approve the user's request to access the digital media file by providing a presentation of the determined version of the digital media file to the client device 119, causing the client device 119 to present the determined version of the digital media file to the user.

For example, assume that an owner of a digital movie file has upgraded the movie to a BD version and that the owner may allow his friends to access the BD version of the movie. If a friend of the owner has been allowed to access the movie, the access module 208 may provide the BD version of the movie to a client device 119 associated with the friend for presenting the BD version of the movie to the friend. However, if another user who is not a friend of the owner has been allowed to access the movie, the access module 208 may provide the standard version of the movie to a client device 119 associated with the other user for presenting the standard version of the movie to the other user.

The lending module 210 may be software including routines for loaning a digital media file from an owner of the digital media file to another user. In some embodiments, the lending module 210 may receive a borrowing request from a user that requests to borrow a digital media file from an owner of the digital media file. For example, the user may be a friend of the owner. The friend of the owner may search for the owner's digital media files and may request to borrow a particular digital media file from the owner.

In some embodiments, a digital media file may be accessed by a single user at a time. Responsive to receiving the borrowing request from the user, the lending module 210 may determine whether an access right of the digital media file has been granted to another user. If the access right of the digital media file has been granted to another user, the lending module 210 may refuse the user's borrowing request to borrow the digital media file because the digital media file may be accessed by a single user at one time. For example, if the digital media file has been loaned to another user and the loan term for the other user has not yet expired, the lending module 210 may refuse to loan the digital media file to the user. In another example, if the digital media file is currently used by the owner (e.g., the owner currently marks the digital media file as unavailable for sharing), the lending module 210 may refuse to loan the digital media file to the user. However, if the access right of the digital media file has not been granted to another user, the lending module 210 may determine that the digital media file is available for lending to the user.

Alternatively, in some embodiments, a digital media file may be accessed by a limited number of users at one time. For example, a digital media file may be accessed by 2, 4, 6, 8, or some other number of users at one time. In these and other embodiments, the lending module 210 may determine whether an access right of the digital media file has been granted to a maximum amount of other users. If the access right of the digital media file has been granted to a maximum number of other users, the lending module 210 may refuse the user's borrowing request to borrow the digital media. However, if the total number of users granted with the access right of the digital media file is less than the maximum number of users, the lending module 210 may determine that the digital media file may still be available for lending to the user.

For example, assume a digital media file may be accessed by up to three users at one time. The lending module 210 may determine whether an access right of the digital media file has been granted to three users. If the access right of the digital media file has been granted to three users, the lending module 210 may refuse the user's borrowing request to borrow the digital media file. However, if the access right has been granted to two users, the lending module 210 may determine that the digital media file may be still available for lending to the user.

Thus, when the digital media file is available for lending to the user, the lending module 210 may further determine whether the user is in a share list of the digital media file. For example, if no other user has borrowed the digital media file from the owner and the digital media file is not currently in use by the owner, the lending module 210 may determine whether the user is in a share list of the digital media file. As another example, if two users have borrowed the digital media file from the owner but up to three users may be granted access rights at the same time, the lending module 210 may determine whether the user is in a share list of the digital media file.

If the user is not in the share list of the digital media file, the lending module 210 may deny the user's borrowing request to borrow the digital media file. In some embodiments, the lending module 210 may notify the owner of the user's borrowing request, so that the owner may determine whether to lend the digital media file to the user even though the user is not in the share list.

Alternatively, if the user is in the share list and the digital media file is also available for lending, the lending module 210 may loan the digital media file to the user. In some embodiments, the lending module 210 may request for the owner's confirmation to loan the digital media file to the user even if the user is already in the share list. The lending module 210 may also configure a loan term for the user and may loan the digital media file to the user by granting the user with an access right to access the digital media file during the loan term. For example, the lending module 210 may loan the digital media file to the user for seven days so that the user may use the client device 119 to access the digital media file at any time during those seven days. The lending module 210 may send an authorization code to the client device 119 so that the user may use the authorization code to access the digital media file during the loan term.

As a result, the user may temporarily gain access to the digital media file during the loan term. If the digital media file may be accessed by a single user at a time, other users including the owner of the digital media file are precluded from accessing the digital media file during the loan term. However, if the digital media file may be accessed by more than one user at a time and the total number of users that have been granted the access right of the digital media file has not reached the maximum number of users, another user in the share list of the digital media file may also be granted the access right to access the digital media file.

In some embodiments, the owner of the digital media file may ultimately retain control of the digital media file, regardless of a loan term of the digital media file. In other words, if the owner loans the digital media file to another user for a certain time period, the owner may retain the ability to revoke the loan term and may reinstate his access to the digital media file at any time. In some other embodiments, the lending interaction may be governed by the loan agreements established at the time of the loan. For example, if the owner agrees to loan his digital media file to a friend for a certain time period and the loan agreement indicates that the time of the loan may not be shortened, the owner may not be able to shorten the loan term.

After approving the loaning of the digital media file to the user, the lending module 210 may set one or more timers to track the loan time of the digital media file based on the loan term. For example, the lending module 210 may set a server timer in the server 109 for tracking the loan time in the server 109 and a client timer in the client device 119 associated with the user for tracking the loan time in the client device 119. The server timer and the client timer may go off simultaneously when the loan term expires.

When the server timer and the client timer expire, indicating the loan term expires, the lending module 210 may revoke the user's access right to access the digital media file. The lending module 210 may return the access right of the digital media file to the owner. For example, the lending module 210 may terminate the user's access to the digital media file from the client device 119 and may remove the digital media file or access information of the digital media file from the client device 119. The lending module 210 may terminate loaning the digital media file to the user and may allow the owner to access the digital media file or to lend the digital media file to other users.

It may be beneficial to use dual timers (e.g., one server timer in the server 109 and one client timer in the client device 119) to track the loan time. For example, even if the client device 119 is not connected to the server 109 when the loan term expires, the client timer in the client device 119 that expires at the same time as the server timer may still notify the user that the loan term expires. The expiration of the client timer may cause the client device 119 to terminate the user's access to the digital media file using the client device 119. If the digital media file has been downloaded to the client device 119, the digital media file may also be removed from the client device 119.

In some embodiments, a user that is approved to borrow a digital media file from an owner may request to extend a loan term for the digital media file before the loan term expires. For example, assume the lending module 210 has lent a digital media file to a user for a first loan term. The lending module 210 may set a server timer in the server 109 and a first client timer in a first client device 119 for tracking the loan time. Before the server timer and the first client timer expire (e.g., while the user still has the access right to access the digital media file), the user may request to borrow the digital media file again using a second client device 119 or the first client device 119. In some embodiments, the lending module 210 may lend the digital media file again to the user and may configure a second loan term for the user. Alternately or additionally, the lending module 210 may request permission from the owner of the digital media file to lend the digital media file again to the user. In these and other embodiments, when the owner approves the user's request, the lending module 210 may configure a second loan term for the user. In some examples, the second loan term may have the same duration as the first loan term. For example, both the first loan term and the second loan term may have a duration of seven days. In some examples, the second loan term may have a different duration from the first loan term. The lending module 210 may set a second client timer in the second client device 119 based on the second loan term, or reset the first client timer in the first client device 119 based on the second loan term.

In some embodiments, the second client timer in the second client device 119 may expire after the expiration of the first client timer in the first client device 119. The lending module 210 may prolong a total loan term for the first user based on the first loan term and the second loan term. For example, the lending module 210 may prolong a total loan term for the user to cover both the first loan term and the second loan term. The lending module 210 may extend the server timer based on the second client timer so that the server timer and the second client timer will expire simultaneously. In this case, even if the first client timer expires, the user may still access the digital media file stored in the server 109 until the second client timer expires because the server timer is extended to expire at the same time as the second client timer.

For example, assume initially the user is authorized to access the digital media file from a first client device 119 during a first loan term between Dec. 12, 2013 and Dec. 14, 2013. The lending module 210 may set a server timer and a first client timer to expire on Dec. 14, 2013. On Dec. 13, 2013, the user is again authorized to access the digital media file from a second client device 119 during a second loan term between Dec. 13, 2013 and Dec. 16, 2013. The lending module 210 may prolong a total loan term for the user to expire on Dec. 16, 2013. The lending module 210 may also set a second client timer in the second client device 119 to expire on Dec. 16, 2013. The lending module 210 may also extend the server timer to expire at the same time as the second client timer.

When the server timer and the second client timer expire, indicating the expiration of the second loan term, the lending module 210 may revoke the user's access right to access the digital media file and may return the access right of the digital media file to the owner. The lending module 210 may terminate the user's access to the digital media file from the second client device 119. The lending module 210 may remove the digital media file or access information of the digital media file from the second client device 119.

In some embodiments, the lending module 210 may also extend the first client timer based on the second client timer so that the first client timer and the second client timer may expire at the same time. Thus, access to the digital media file from the first client device 119 is extended until the prolonged first client timer expires. Alternatively, in some embodiments, the lending module 210 may not extend the first client timer. In these and other embodiments, the user may use the first client device 119 to access the digital media file until the first client timer expires.

The sales module 212 may be software including routines for selling or purchasing media content. In some embodiments, the sales module 212 may receive a sell request from an owner of a hard-copy media implementation stored in the repository 111. The sales module 212 may sell the hard-copy media implementation and/or a corresponding digital media file to another user. The sales module 212 may transfer ownership of the digital media file and/or the hard-copy media implementation from the owner to the purchasing user. The sales module 212 may add the revenue received from selling the media content to the owner's account.

After the sale, the purchasing user may continue using the digital media file of the purchased hard-copy media implementation and accessing the digital media file via the network 105. Alternatively, the purchasing user may request to cancel or delete the digital media file from the storage device 135 and to have the hard-copy media implementation removed from the repository 111 and transferred to the purchasing user.

In some embodiments, the sales module 212 may receive a purchase request from a user that requests to purchase new media content from the media source 107. The sales module 212 may purchase the new media content from the media source 107 for the user. The purchase of new media content from the media source 107 may include a digital media file, a hard-copy media implementation shipped to the user's physical address, or both a hard-copy media implementation (stored in the repository 111) and a digital version of the hard-copy media implementation (stored in the storage device 135).

The account module 214 may be software including routines for managing a user's interaction with the media management apparatus 113. The interactions that are managed by the account module 214 may include limitations on the number of digital media files a user may hold at a given time. For example, a user may enroll for a temporary trial account for a certain time period and may have access rights to a single digital media file at one time. In some embodiments, the account module 214 may control the fees involved with participating in the media management system 100. Generally, the account module 214 may control the administrative data collection related to the media management system 100, such as user registration, user billing, and user accounts, etc.

The analytics module 216 may be software including routines for analyzing user data and corresponding media data associated with users. For example, the analytics module 216 may collect, monitor, and/or control the collection of data related to users and corresponding media data. The corresponding media data may include information, data, statistics, or trends related to users' media preferences. The corresponding media data may also include information describing the statistics or trends relating to accessing, loaning, borrowing, selling, and purchasing media content. For example, the analytics module 216 may track a total number of digital media files owned by a user and may analyze the statistics and trends describing which users are using or loaning the digital media files.

In some embodiments, the analytics module 216 may monitor and record any type of analytical data that is received by or utilized in the modules of the media management apparatus 113, including the conversion module 204, the access module 208, the lending module 210, the sales module 212, the account module 214, the advertising module 218, the search module 222, the feature module 224, the upgrade module 226, and the payment module 228, etc. In some embodiments, the analytics module 216 may further include selling such analytical and statistical data to third parties such as the media sources 107. Alternatively or additionally, the analytical and statistical data may be utilized by the advertising module 218 to customize advertisements for users.

The advertising module 218 may be software including routines for providing advertisements to users. For example, the advertising module 218 may receive advertisement information or promotion information related to media content from one or more media sources 107. The advertising module 128 may provide the advertisement information or promotion information to users when the users are viewing digital media files in the media management system 100. In some embodiments, the one or more media sources 107 are registered sellers providing media content that may be offered for sale via the sales module 212. The media content may include hard-copy media implementations and/or digital media files.

The user interface module 220 may be software including routines for generating graphical data for providing user interfaces to users. In some embodiments, the user interface module 220 may generate graphical data for providing a user interface to an owner of a digital media file, allowing the owner to configure a file setting and/or a share setting of the digital media file. The user interface module 220 may send the graphical data to the client device 119 associated with the owner, causing the client device 119 to present the user interface to the owner. The user interface module 220 may also generate graphical data or other data for providing other user interfaces to users.

The search module 222 may be software including routines for assisting users to search for media content. For example, the search module 222 may receive a search query from a user and may search for digital media files that match the search query. In some embodiments, the search module 222 may return a search result including digital media files owned by other users that are connected to the user. For example, the search module 222 may return digital media files matching the search query and owned by friends of the user.

The user may request to borrow digital media files from friends via links in the search result. In some embodiments, the search module 222 may not return digital media files owned by other users that are not connected to the user. For example, the search result may not include digital media files owned by other users that are not friends of the user. If users connected to the user do not have digital media files matching the user's search query, the search module 222 may return a search result with digital media files from the media source 107, allowing the user to purchase the digital media files from the media source 107.

The feature module 224 may be software including routines for editing a presentation of a digital media file by adding one or more features to the presentation of the digital media file. For example, the feature module 224 may receive a request from a user to add one or more features to a presentation of a digital media file and may instruct the payment module 228 to request the user to pay for the one or more features. Responsive to the payment module 228 receiving a payment for the one or more features, the feature module 224 may add the one or more features to the presentation of the digital media file. In some examples, the feature module 224 may add the one or more features to the presentation of the digital media file for free. However, the addition of the one or more features to the digital media file may not violate the copyright protection of the digital media file. For example, the addition of the one or more features in the presentation of the digital media file may not modify the copyright-protected content included in the digital media file.

For example, assume a movie DVD does not include a subtitle for the movie. A user that is permitted to access the digital movie file of the movie DVD may request to display a subtitle during the replay of the digital movie file. Responsive to the user request, the feature module 224 may retrieve a subtitle matching the movie from the media source 107 and may add the subtitle to the replay of the movie. As another example, the feature module 224 may translate a first language associated with an audio book to a second language and may replay the audio book using the second language. In yet another example, a user may request to replace a French subtitle shown in a movie to a Japanese subtitle. The feature module 224 may search for a Japanese subtitle matching the movie from the media source 107 and/or a content server (not shown). The feature module 224 may replace the French subtitle with the Japanese subtitle during the replay of the movie.

In some embodiments, the feature module 224 may allow the user to provide annotations or comments on the content of the digital media file and may pinpoint the user's annotations or comments to a particular portion of the digital media file. For example, during the replay of a digital movie file, the feature module 224 may allow the user to post comments describing a particular scene of the movie and may associate the user's comments with the particular scene. When other users watch the movie, the user's comments may be displayed to the other users during the replay of the particular scene. The user may also share the comments and the pinpoint location of the scene with friends in a social network.

In some embodiments, the feature module 224 may add one or more features to a digital media file after the conversion module 204 converts an artistic item on a hard-copy media implementation to a digital media file. An owner of the digital media file may request the feature module 224 to add the one or more features to the digital media file so that the added features may be presented to users during the presentation of the digital media file. Alternatively or additionally, in some embodiments, a user may request to add one or more features to a digital media file during a presentation process of the digital media file. The user may be an owner of the digital media file or a user granted with an access right to access the digital media file.

In some embodiments, the feature module 224 may be configured to edit a presentation of a digital media file. For example, the feature module 224 may allow a user to customize the presentation of the digital media file by adding one or more features to the presentation, while the one or more features may not be available when directly playing the hard-copy media implementation using a player device. As another example, a subtitle of a movie in a particular language may not be available when playing a movie DVD. However, if the user replays a digital media file derived from the movie DVD, the feature module 224 may search for a subtitle in the particular language online and may add the subtitle to the replay of the digital media file.

In some embodiments, a digital media file may include a digital video file that may be replayed using a digital video player application. During the replay of the digital video file, the digital video player application may act upon the artistic content in the digital video file and may add one or more features to the digital video file without modifying the artistic content in the digital video file. For example, the digital video player application may configure the artistic content as an original content layer and may overlay the original content layer with one or more additional feature layers. Example feature layers may include, but are not limited to, adding a subtitle to the digital video file, adjusting pixel intensities or pixel grayscales in one or more video frames, muting audio during replay of one or more video frames, skipping one or more video frames, removing inappropriate content from the original content layer, and other suitable feature layers. As a further example, the digital video player application may overlay a feature layer upon the original content layer so that pixel intensities (e.g., intensities of red, green, and blue colors) in one or more video frames may be adjusted. The digital video player application may mask the one or more additional feature layers over the original content layer. The digital video player application may present the original content layer that is overlaid with the one or more additional feature layers to users.

The upgrade module 226 may be software including routines for upgrading media content. In some embodiments, the upgrade module 226 may receive a request from a user to upgrade a digital media file and may instruct the payment module 228 to request the user to pay for the upgrade of the digital media file. Responsive to the payment module 228 receiving a payment for the upgrade, the upgrade module 226 may upgrade the digital media file from a current version to another version with better quality. For example, the upgrade module 226 may upgrade a digital media file such as a movie from a standard version to a HD version. In another example, the upgrade module 226 may upgrade a DVD owned by a user and stored in the repository 111 to a Blu-ray disc. In some embodiments, the upgrade module 226 may upgrade the digital media file for free.

In some embodiments, an owner of a hard-copy media implementation may request to upgrade one or more digital media files to better versions after artistic content on the hard-copy media implementation has been converted to the one or more digital media files. Alternatively or additionally, in some embodiments, a user may request to upgrade a digital media file during a presentation process of the digital media file. For example, the user may request to upgrade a movie from a standard version to a HD version during the replay of the movie. The user may be an owner of the digital media file or a user granted with the access right to access the digital media file.

In some embodiments, a user that has paid for an upgrade of a digital media file may specify a group of users that are allowed to access the upgraded version of the digital media file. For example, the user may be an owner of the digital media file. In some embodiments, if the upgrade module 226 has approved a user's request to upgrade a digital media file and has upgraded the digital media file accordingly, the user may specify a group of other users that are allowed to access the upgraded version of the digital media file. In these or other embodiments, an owner of the digital media file may specify which user may be allowed to access which version of the digital media file.

In some embodiments, the upgrade module 226 may also allow users to upgrade the rights associated with the digital media files. For example, a user may send a DVD to the repository 111 and may subsequently receive access to the corresponding digital version of the DVD. The user may only have the standard use, copy, and distribution rights associated with the DVD. However, the upgrade module 226 may facilitate the user in upgrading his rights associated with the digital version of the DVD.

For example, the upgrade module 226 may receive a right upgrade request from a user such as an owner of a digital media file. The right upgrade request may request to upgrade an access right of the digital media file from allowing one user to access the digital media file at a time to allowing multiple users to access the digital media file at a time. The upgrade module 226 may request the user to pay for the right upgrade. After the payment module 228 receives a payment for the right upgrade from the user, the upgrade module 226 may upgrade the access right of the digital media file to allow up to a maximum number of users to access the digital media file at one time. The upgrade module 226 may instruct the configuration module 206 to reconfigure the share setting to allow up to the maximum number of users to access the digital media file at one time.

The payment module 228 may be software including routines for handling payments received from users. In some embodiments, responsive to receiving an upgrade request from a user, the payment module 228 may request the user to pay for the upgrade of a digital media file and/or a hard-copy media implementation. The payment module 228 may receive a payment for the upgrade from the user and may instruct the upgrade module 226 to upgrade the digital media file and/or the hard-copy media implementation correspondingly.

In some embodiments, the payment module 228 may request a user to pay for one or more features added to a presentation of a digital media file. The payment module 228 may receive a payment for the one or more features from the user and may instruct the feature module 224 to add the one or more features to the presentation of the digital media file.

FIG. 3 is a flowchart of an example method 300 of accessing media content, according to at least one embodiment described herein. Although illustrated as discrete blocks, various blocks may be divided into additional blocks, combined into fewer blocks, or eliminated, depending on the desired implementation. The method 300 may be performed by and is explained in context of the media management apparatus 113 of FIGS. 1 and 2. Other systems or apparatuses may also perform the method 300.

The method 300 may begin at block 301, where the conversion module 204 may convert an artistic item on a hard-copy media implementation to a digital media file. In some embodiments, the hard-copy media implementation may include a single artistic item that may be converted to a single digital media file. For example, a movie stored on a DVD may be converted to a single digital media file with an mp4 format. Alternatively, in some embodiments, the hard-copy media implementation may include multiple artistic items and each artistic item may be converted to one digital media file. For example, each track on a CD may be converted to one digital media file with an mp3 format. In these or other embodiments, multiple artistic items on the hard-copy media implementation may also be converted to a single digital media file. For example, artistic content stored on a music CD may be converted to a digital media file that includes all of the songs on the music CD.

At block 302, the communication module 202 may receive a first request to access the digital media file from a client device 119. At block 304, the access module 208 may determine whether the digital media file is available for the client device 119 to access. In some embodiments, the access module 208 may determine whether an access right of the digital media file is available for a user associated with the client device 119 and whether the user is in a share list of the digital media file. In some embodiments, the access module 208 may determine whether an access right of the digital media file has been granted to the user associated with the client device 119. For example, the access module 208 may determine whether the user has already borrowed the digital media file from an owner of the digital media file. In another example, the access module 208 may determine whether the user associated with the client device 119 is an owner of the digital media file and whether the total number of other users granted with the access right of the digital media file is less than the maximum number of users allowed to access the digital media file at a time.

If the digital media file is available for the client device 119 to access (e.g., the user has borrowed the digital media file from the owner of the digital media file, or the user is the owner of the digital media file and the total number of other users granted with the access right of the digital media file is less than the maximum number of users), the method 300 may proceed to block 306. Otherwise, the method 300 may proceed to block 305. At block 305, the access module 208 may deny the user's request to access the digital media file.

At block 306, the access module 208 may approve the first request from the client device 119 by providing a presentation of the digital media file to the client device 119 so that the client device 119 may present the digital media file to the user. At block 308, the communication module 202 may receive, from the client device 119, a second request to add one or more features to the presentation of the digital media file. At block 310, the feature module 224 may add the one or more features to the presentation of the digital media file responsive to receiving the second request.

One skilled in the art will appreciate that, for the method 300 and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 4 is a flowchart of an example method 400 of creating a digital media file from a hard-copy media implementation, according to at least one embodiment described herein. Although illustrated as discrete blocks, various blocks may be divided into additional blocks, combined into fewer blocks, or eliminated, depending on the desired implementation. The method 400 may be performed by and is explained in context of the media management apparatus 113 of FIGS. 1 and 2. Other systems or apparatuses may also perform the method 400.

The method 400 may begin at block 402, where an administrator operating on the repository 111 may receive a hard-copy media implementation from an owner of the hard-copy media implementation. The administrator may store the hard-copy media implementation in the repository 111. In some embodiments, the conversion module 204 may verify that the hard-copy media implementation is a legal hard copy of the hard-copy media implementation. At block 404, the conversion module 204 may convert an artistic item on the hard-copy media implementation to a single digital media file.

At block 406, the communication module 202 may receive a request to add one or more features to the digital media file from a user. The user may be an owner of the digital media file. At block 408, the payment module 228 may receive a payment for the one or more features. At block 410, the feature module 224 may add the one or more features to the digital media file such that the one or more features may be presented to users during the presentation of the digital media file.

At block 412, the communication module 202 may receive a request to upgrade the digital media file from the user. At block 414, the payment module 228 may receive a payment for upgrading the digital media file. At block 416, the upgrade module 226 may upgrade the digital media file. The upgraded digital media file may be accessed by the user as well as other users granted with the access right to access the digital media file. For example, the upgraded digital media file may be accessed by the user that has paid for the upgrade. In another example, the upgraded digital media file may be accessed by one or more other users that the user has allowed to access the upgraded digital media file. The upgrade module 226 may store the upgraded digital media file in the storage device 135.

One skilled in the art will appreciate that, for the method 400 and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIGS. 5A and 5B are flowcharts of another example method 500 of accessing media content, according to at least one embodiment described herein. Although illustrated as discrete blocks, various blocks may be divided into additional blocks, combined into fewer blocks, or eliminated, depending on the desired implementation. The method 500 may be performed by and is explained in context of the media management apparatus 113 of FIGS. 1 and 2. Other systems or apparatuses may also perform the method 500.

Referring to FIG. 5A, the method 500 may begin at block 502, where the communication module 202 may receive a request to access a digital media file from a user. For example, the communication module 202 may receive the request to access the digital media file from a client device 119 operated by the user. At block 504, the access module 208 may determine whether an access right of the digital media file has been granted to the user. If the access right of the digital media file has been granted to the user, the method 500 may proceed to block 508. Otherwise, the method 500 may proceed to block 506. At block 506, the access module 208 may deny the user's request to access the digital media file.

At block 508, the access module 208 may approve the user's request to access the digital media file. For example, the access module 208 may present the digital media file to the user using the client device 119 associated with the user. At block 510, the communication module 202 may receive a request from the user to add one or more features to the presentation of the digital media file. For example, the communication module 202 may receive the request to add the one or more features to the presentation of the digital media file from the client device 119 operated by the user. At block 512, the payment module 228 may request the user to pay for the one or more features. At block 514, the payment module 228 may receive a payment for the one or more features from the user. At block 516, the feature module 224 may add the one or more features to the presentation of the digital media file.

Referring to FIG. 5B, at block 518, the communication module 202 may receive a request from the user to upgrade the digital media file. For example, the communication module 202 may receive the request to upgrade the digital media file from the client device 119 operated by the user. At block 520, the payment module 228 may request the user to pay for the upgrade of the digital media file. At block 522, the payment module 228 may receive a payment for the upgrade of the digital media file from the user. At block 524, the upgrade module 226 may upgrade the digital media file.

At block 526, the access module 208 may determine whether a loan term for loaning the digital media file to the user has expired. If the loan term has expired, the method 500 may proceed to block 528. Otherwise, the method 500 may proceed to block 527. At block 527, the access module 208 may continue allowing the user to access the digital media file, and the method 500 may proceed to block 526. At block 528, the lending module 210 may revoke the access right of the digital media file granted to the user. At block 530, the access module 208 may terminate the user's access to the digital media file.

One skilled in the art will appreciate that, for the method 500 and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 6 is a graphic representation 600 of an example record describing an association between a hard-copy media implementation and a digital media file converted from the hard-copy media implementation, according to at least one embodiment described herein. The example record may describe that artistic content on a hard-copy media implementation (e.g., a DVD) is converted to a digital media file (e.g., movie.mp4). The digital media file may be associated with an authorization code 602, an owner 604, and a share list 606 including a group of users for sharing the digital media file. The owner 604 of the digital media file may perform one or more actions with respect to the digital media file, including selecting a “sell” button 608 to sell the digital media file and the DVD, an “add feature” button 610 to add a feature to the digital media file, and an “upgrade to HD” button 612 to upgrade the digital media file to an HD version.

As described above, the embodiments described herein may include the use of a special purpose or general purpose computer (e.g., the processor 115 of FIG. 1) including various computer hardware or software modules, as discussed in greater detail below. The special purpose or general purpose computer may be configured to execute computer-executable instructions stored on computer-readable media (e.g., the memory 117 and/or the storage device 135 of FIG. 1).

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the present disclosure.

What is claimed is:

1. A method for accessing media content, the method comprising:
converting an artistic item on a hard-copy media implementation to a digital media file;
receiving a first request to access the digital media file from a client device;
determining that the digital media file is available for the client device to access;
approving the first request by providing a presentation of the digital media file to the client device;
receiving, from the client device, a second request to add one or more features to the presentation of the digital media file; and
adding the one or more features to the presentation of the digital media file.

2. The method of claim 1, further comprising:
receiving a third request to upgrade the digital media file;
receiving a payment for the upgrade of the digital media file; and
upgrading the digital media file responsive to receiving the payment.

3. The method of claim 1, further comprising:
receiving a payment for the one or more features, wherein the one or more features are added to the presentation of the digital media file responsive to receiving the payment.

4. The method of claim 1, wherein adding the one or more features to the presentation of the digital media file comprises:
adding a subtitle to the presentation of the digital media file.

5. The method of claim 1, wherein adding the one or more features to the presentation of the digital media file comprises:
translating a first language associated with the digital media file to a second language.

6. The method of claim 1, wherein the digital media file is configured to be accessed by a maximum number of users at a time.

7. The method of claim 6, wherein the maximum number of users is one.

8. The method of claim 1, wherein determining that the digital media file is available for the client device to access comprises:
determining that an access right of the digital media file has been granted to a user associated with the client device.

9. The method of claim 1, wherein determining that the digital media file is available for the client device to access comprises:
determining that the client device is associated with an owner of the digital media file; and
determining that a total number of users granted with the access right of the digital media file is less than a maximum number of users.

10. A computer-readable storage medium including instructions that cause a system to perform operations to access media content, the operations comprising:
converting an artistic item on a hard-copy media implementation to a digital media file;
receiving a first request to access the digital media file from a client device;
determining that the digital media file is available for the client device to access;
approving the first request by providing a presentation of the digital media file to the client device;
receiving, from the client device, a second request to add one or more features to the presentation of the digital media file; and
adding the one or more features to the presentation of the digital media file.

11. The computer-readable storage medium of claim 10, wherein the operations further comprise:
receiving a third request to upgrade the digital media file;
receiving a payment for the upgrade of the digital media file; and
upgrading the digital media file responsive to receiving the payment.

12. The computer-readable storage medium of claim 10, wherein the operations further comprise:
receiving a payment for the one or more features, wherein the one or more features are added to the presentation of the digital media file responsive to receiving the payment.

13. The computer-readable storage medium of claim 10, wherein adding the one or more features to the presentation of the digital media file comprises:
adding a subtitle to the presentation of the digital media file.

14. The computer-readable storage medium of claim 10, wherein adding the one or more features to the presentation of the digital media file comprises:
translating a first language associated with the digital media file to a second language.

15. The computer-readable storage medium of claim 10, wherein the digital media file is configured to be accessed by a maximum number of users at a time.

16. The computer-readable storage medium of claim 15, wherein the maximum number of users is one.

17. The computer-readable storage medium of claim 10, wherein determining that the digital media file is available for the client device to access comprises:
determining that an access right of the digital media file has been granted to a user associated with the client device.

18. The computer-readable storage medium of claim 10, wherein determining that the digital media file is available for the client device to access comprises:
determining that the client device is associated with an owner of the digital media file; and
determining that a total number of users granted with the access right of the digital media file is less than a maximum number of users.

19. A system for accessing media content, the system comprising:
a processor; and
a memory storing instructions that, when executed, cause the system to:
convert an artistic item on a hard-copy media implementation to a digital media file;
receive a first request to access the digital media file from a client device;
determine that the digital media file is available for the client device to access;
approve the first request by providing a presentation of the digital media file to the client device;
receive, from the client device, a second request to add one or more features to the presentation of the digital media file; and
add the one or more features to the presentation of the digital media file.

20. The system of claim 19, wherein the instructions when executed cause the system to also:
receive a third request to upgrade the digital media file;
receive a payment for the upgrade of the digital media file; and
upgrade the digital media file responsive to receiving the payment.
